(19) United States
(12) Patent Application Publication
(10) Pub. No.: US 2023/0284005 A1
(43) Pub. Date: Sep. 7, 2023

(54) Transitory Emergency Notification and Accountability

(71) Applicant: James Raymond Muench, JR., Depew, NY (US)

(72) Inventor: James Raymond Muench, JR., Depew, NY (US)

(21) Appl. No.: 18/445,145

(22) Filed: May 1, 2023

(51) Int. Cl. H04W 4/90; H04W 4/06

(52) U.S. Cl. CPC H04W 4/90; H04W 4/06

(57) ABSTRACT

The invention is a wireless communication based system that can interface with other devices (Cellphones, satellite phones, tablets, watches . . . etc) it utilizes a camera on the device to scan/check-in/register by means of a code (QR) or other to download the Application. It then requires a form of Government issued identification to be granted access to the system's application (App). Furthermore it creates an Accountability list of persons at a Transitory location in the event of an Incident.

### BACKGROUND OF THE INVENTION

The invention utilizes wireless communication; to include but not limited to cell phones, computers, tablets, smart watches, and satellite phones or similar devices; to send or receive an Emergency Notification or Alert to Guests or Patrons at a Transitory location.

### BRIEF OF ARTWORK

This art comprises of a system utilizing computer software and an “APP’ to be downloaded on the above listed devices listed in paragraph 1.

The App will allow the Transitory location personnel the ability to push an alert to the end users or user to user and to include the user to the Transitory location personnel and furthermore user to a 911 dispatch center/Emergency Dispatch center or the 911 dispatch center to the Transitory location personnel and users/patrons. Further it will require a code (QR) or similar to download the App along with utilizing the devises camera to validate the users Identity; by means of a form of Government issued Identification (Driver License, Passport . . . etc) this will reduce the risk of False Alerts/Notifications by Users/Patrons/Guests.

### BRIEF OF SUMMARY

The Invention will utilize a scannable code by a cellphone or other device with similar capabilities; this scannable code can be a “QR” code but not limited to. Once the user is linked into that specific Transitory location's unique identifiable code, the user is now part of a network comprising of the Transitory location, other users and the 911 Dispatch center for that geographical location. All three entities will have the ability to send or receive Notifications/Alerts.

As with all wireless devices they can all send and receive Notifications/Alerts via wireless communications, to be included in an alert/notification are directions, messages and maps; this is common practice in wireless communications. This invention's system or “App” includes those abovementioned as well.

Current “App's” or mobile applications that are with in this field/scope do not require an Identification of a User that can send a Notification/Alert. This in return could allow for misuse of the “App” and lead to unnecessary responses by First Rsponders (Police, Fire and E.M.S.)

This Invention will require the user to not only scan into the Transitory location and utilize the users various known G.P.S. or cellular location's signals for that geographic location to further prevent misuse.

Furthermore after scanning into a Transitory location the user will need to scan in an acceptable Government Identification into the “App” for two reasons. The first being to prevent misuse/false reporting, the second is this will provide an Accountability list to the Transitory location personnel and to First Responders in the event of an incident.

The Accountability list that can be generated IF an Event/Incident occurs would be an asset to the First Responders, for investigative reasons and search and rescue.

The data would only be retained in the event of an Incident. The data would primarily be held by the Transitory location; but not limited to an Emergency Dispatch center or Law Enforcement.

The User/Patron/Guest upon scanning or checking-in to the location via code (QR) or other and scanning the Government Identification would then select the length of stay at said Transitory location. Once the Length of Stay or Duration of Event (ex. Hotel, Motel, Concert, Resort, Sporting Event or any and all Transitory locations that include mass gatherings.) has ended or is over the users personnel Identifying Information would be Deleted/Purged from the system.

The invention system would also collect the devices IMEI number (International Mobile Equipment Identity), this would further prevent misuse and assist Law Enforcement.

The Transitory Emergency Notification and Accountability system will function as a user to user to Transitory Location's personnel system and can be Independent of 911 Dispatch centers/Emergency Dispatch; depending on what the Transitory location request, but not limited to consulting with Government Entities (Local, County, State, Federal).

Since the system requires the Government Identification and collects the devices IMEI number; this will not require verification step's in order to send an alert/notification.

The system is fully able to integrate with other software; to include acoustic sound detection systems and others (ex. Gunshot, explosion, Chemical, Biological, Radioactive and Nuclear) that once activated could automatically send an alert/notification.

As previously stated in Paragraph 15 the system would also be able to integrate with surveillance camera's.

### DESCRIPTION OF VIEWS OF DRAWINGS

In FIG. 1 it depicts the system and the continuity of the flow of use and how information will flow.

FIG. 2 depicts what the Invention's system “App” would look like to send a Notification/Alert.

FIG. 3 depicts what the “App” would convey in a message and how the device would alert/notify.

FIG. 4 depicts the device utilizing a code or “QR” code.

FIG. 5 depicts the Transitory Emergency Notification and Accountability system “App” downloaded onto the device.

FIG. 6 depicts the required Government issued Identification to be scanned into the device via device camera and the data sent to the Transitory location/computer.

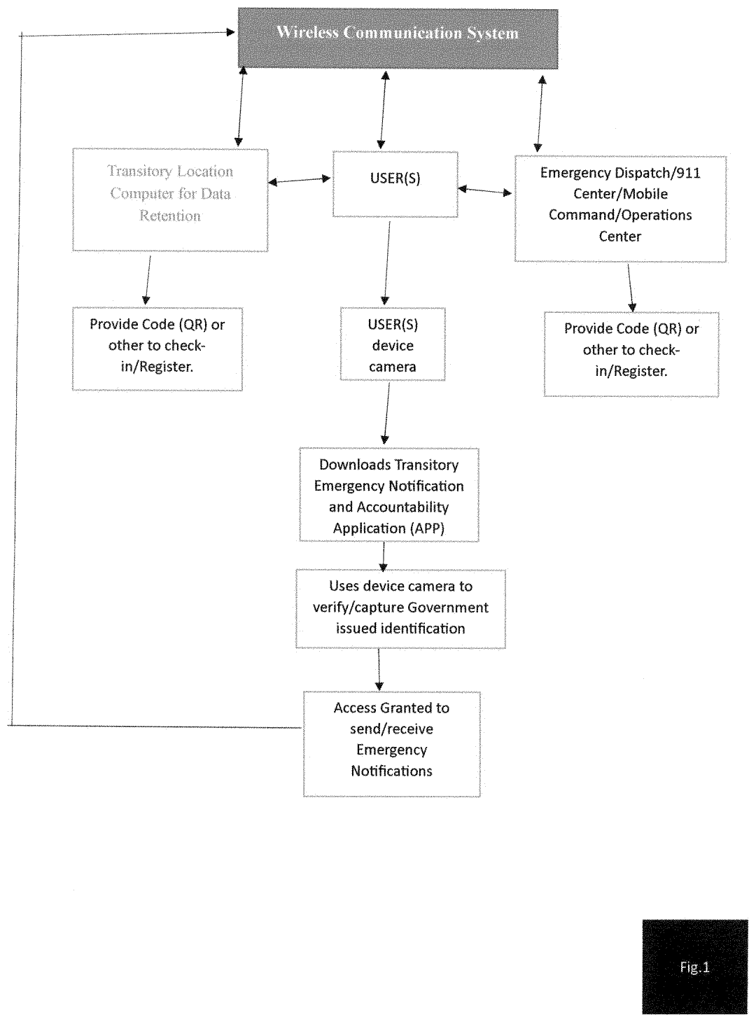

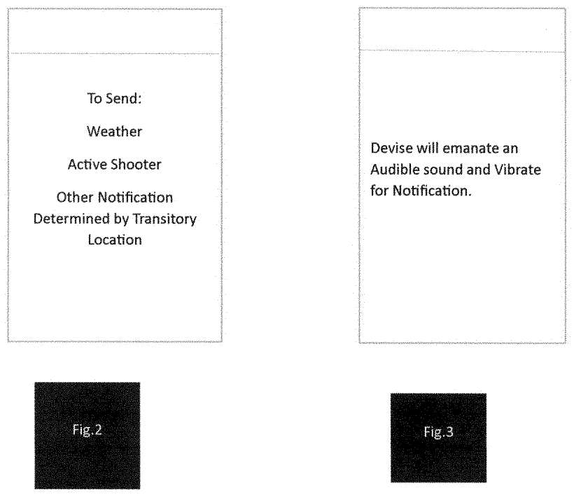

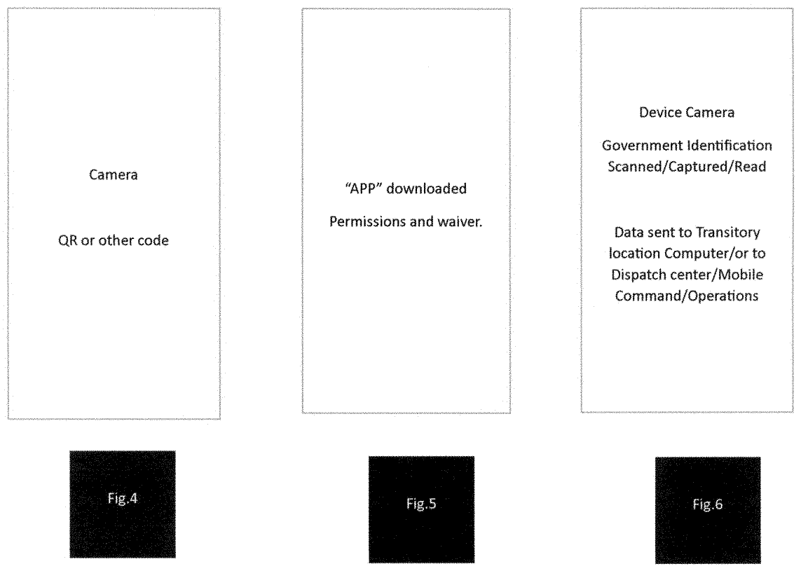

### DETAILED DESCRIPTION OF INVENTION

The Invention will utilize a wireless communication system to interface between a transitory location's computer, user(s), and an Emergency dispatch center or mobile command center computer or devices, utilizing cellular, wifi, all types of internet and satellite communications. The process and system is clearly detailed herein the entire document enclosed within this application for consideration. As stated in the claims section this Invention is unique in that it requires Government issued identification (ex. Drivers License, Passport, Military Geneva conventions identification card . . . etc) to verify and grant access to the system to a user at a Transitory location (Hotel, Resort, Concert, Parade . . . etc) to send or receive an emergency notification/alert and to provide an immediate accountability list of all users/Patrons/Guests.

1. This invention provides real time intelligence to the Transitory location, User(s) and Emergency dispatch center, and allows all to “Push/send” the Emergency Notification to all others on the system during the specified length of time at the location of duration of the event.
This invention's further distinguishing claim is that by requiring a Government issued Identification; it does temporarily store the users personal identifying information; which will reduce false notifications and in doing so will aide Law Enforcement in the investigation phase of an incident/event whether real or falsely reported.
invention system's App further aides Law Enforcement in the storing of the IEMI.
In the event of an incident, whether false or real the invention creates an accountability list of persons at the Transitory location by the means discussed previously in the entirety of the document and application.
